(19) United States
(12) Patent Application Publication
(10) Pub. No.: US 2019/0308745 A1
(43) Pub. Date: Oct. 10, 2019

(54) METHOD AND SYSTEM FOR CONTROLLING MISSION OF UNMANNED AERIAL VEHICLE ON BASIS OF USER POSITION

(71) Applicant: Electronics and Telecommunications Research Institute, Daejeon (KR)

(72) Inventors: Myung Seok KI, Daejeon (KR); Sang Hyouk CHOI, Seoul (KR); Yun Su BOK, Sejong-si (KR); Ji Hwan SON, Sejong-si (KR); Jeong Hwan LEE, Hwaseong-si Gyeonggi-do (KR); Ji Hun CHA, Daejeon (KR); Jae Young AHN, Daejeon (KR)

(73) Assignee: Electronics and Telecommunications Research Instit ute, Daejeon (KR)

(21) Appl. No.: 16/375,619

(22) Filed: Apr. 4, 2019

(30) Foreign Application Priority Data
Apr. 4, 2018 (KR) 10-2018-0039095
Dec. 11, 2018 (KR) 10-2018-0159160

(51) Int. Cl. B64D 45/00; G05D 1/00; B64C 39/02

(52) U.S. Cl. CPC B64D 45/00; G05D 1/0022; H04W 4/029; B64C 2201/146; B64C 39/024

(57) ABSTRACT

The present invention provides a method of controlling an unmanned aerial vehicle by a system for controlling a mission of the unmanned aerial vehicle on the basis of a user position. Herein the method includes acquiring information related to a position of the terminal; performing authentication for the unmanned aerial vehicle on the basis of the information related to the position of the terminal; and, when the authentication is completed, transmitting the information related to the position of the terminal to the unmanned aerial vehicle.

### CROSS REFERENCE TO RELATED APPLICATION

The present application claims priority to Korean Patent Applications No. 10-2018-0039095, filed Apr. 4, 2018 and No. 10-2018-0159160, filed Dec. 11, 2018, the entire contents of which are incorporated herein for all purposes by this reference.

### BACKGROUND OF THE INVENTION

### Field of the Invention

The present invention relates generally to a method and a system for controlling a mission of an unmanned aerial vehicle on the basis of a user position. More particularly, the present invention relates to a method of transmitting position information of an unmanned aerial vehicle user or a third person having a device capable of determining the position to the unmanned aerial vehicle via communication, utilizing the position information received by the unmanned aerial vehicle, and providing a format for the information transmitted to the unmanned aerial vehicle via communication.

### Description of the Related Art

With the development of unmanned aerial vehicle technology, research on the unmanned aerial vehicle has been carried out for application in various fields such as surveillance, delivery, and disaster area management over wide areas. Especially, by mounting a variety of sensor hardware in the unmanned aerial vehicle, research on autonomous flight technology has been carried out to perform autonomous flight and mission performance without use control. As an example, as a fundamental autonomous flight technology, there is a flight controller (FC) which provides an automatic return function that enables the unmanned aerial vehicle to return to the starting position after flight.

However, most return technology of unmanned aerial vehicles is performed in such a manner as to record the starting point using the GPS included in the unmanned aerial vehicle at the time of start and return to the starting point after flight. Therefore, the unmanned aerial vehicle user should always wait for the unmanned aerial vehicle at the start position when the unmanned aerial vehicle is returned. When the return position changes, for example, when the unmanned aerial vehicle departs from a boat or a moving starting point, there is difficulty in operation. In addition, since battery technology has developed slowly compared with the current technology of the unmanned aerial vehicle, it is difficult to operate the unmanned aerial vehicle over a long distance for a long time because general unmanned aerial vehicle has flight time less than 30 minutes.

### SUMMARY OF THE INVENTION

An object of the present invention is to provide a method of returning an unmanned aerial vehicle to a user position rather than a starting position when an unmanned aerial vehicle performs a return function.

An object of the present invention is to provide a method of setting a user position to a return position and tracking the user position by an unmanned aerial vehicle through a device capable of estimating the user position.

An object of the present invention is to provide a method and a system for returning automatically an unmanned aerial vehicle to increase the mission performance and efficiency of the unmanned aerial vehicle.

It is an object of the present invention to provide a transmission format for transmitting information on an unmanned aerial vehicle.

According to an embodiment of the present invention, there provided a method of controlling an unmanned aerial vehicle by a terminal in a system for controlling a mission of the unmanned aerial vehicle. The method includes acquiring information related to a position for the terminal; performing authentication for the unmanned aerial vehicle on the basis of the information related to the position of the terminal; and when the authentication is completed, transmitting the information related to the position of the terminal to the unmanned aerial vehicle.

According to an embodiment of the present invention, there provided a method of controlling an unmanned aerial vehicle in a system for controlling a mission of an unmanned aerial vehicle. The method includes receiving information related to a position from a terminal; and performing mission control on the basis of the information related to the position, wherein authentication for the unmanned aerial vehicle is performed on the basis of the information related to the position of the terminal, and when the authentication is completed, the information related to the position of the terminal is transmitted to the unmanned aerial vehicle.

According to an embodiment of the present invention, there provided a system for controlling a mission of an unmanned aerial vehicle. The system includes an unmanned aerial vehicle; and a terminal controlling the unmanned aerial vehicle, wherein the terminal acquires information related to a position, the terminal performs authentication for the unmanned aerial vehicle on the basis of the information related to the position, and the terminal transmits the information related to the position of the terminal to the unmanned aerial vehicle when the authentication is completed.

According to an embodiment of the present invention, the information related to the position of the terminal may be transmitted to the unmanned aerial vehicle on the basis of a MAVlink packet.

According to an embodiment of the present invention, the information related to the position may be transmitted on the basis of at least one of a first format and a second format based on the MAVlink packet.

According to an embodiment of the present invention, the first format may be a legacy format based on the MAVlink packet, and the second format may be a format based on the information related to the position.

According to an embodiment of the present invention, when the information related to the position is transmitted to the unmanned aerial vehicle on the basis of the first format, the information related to the position may be included as a predetermined value in the first format.

According to an embodiment of the present invention, when the information related to the position is transmitted to the unmanned aerial vehicle on the basis of the second format, a new value may be set on the basis of the information related to the position, and the information related to the position may be transmitted via the set new value.

According to an embodiment of the present invention, the information related to the position may include at least one of latitude information, longitude information, elevation information, x speed on the ground, y speed on the ground, a heading direction, position update flag information, time information, and safety distance offset information of the terminal.

Herein, according to an embodiment of the present invention, when the position update flag information is a first value, the information related to the position may include only the position update flag information and the time information.

In addition, according to an embodiment of the present invention, when the position update flag information is a second value, the information related to the position may include all of the latitude information, the longitude information, the elevation information, the x speed on the ground, the y speed on the ground, the heading direction, the position update flag information, the time information, and the safety distance offset information.

The features briefly summarized above for the present invention are only illustrative aspects of the detailed description of the present disclosure and are not intended to limit the scope of the present disclosure.

According to the present invention, it is possible to provide a method of returning an unmanned aerial vehicle to a user position rather than a starting position when an unmanned aerial vehicle performs a return function.

According to the present invention, it is possible to provide a method of setting a user position to a return position and tracking the user position by an unmanned aerial vehicle through a device capable of estimating the user position.

According to the present invention, it is possible to provide a method and a system for returning automatically an unmanned aerial vehicle to increase the mission performance and efficiency of the unmanned aerial vehicle.

According to the present invention, it is possible to provide a transmission format for transmitting information on an unmanned aerial vehicle.

The effects obtainable from the present disclosure are not limited to the effects mentioned above, and other effects not mentioned can be clearly understood by those skilled in the art from the description below.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram illustrating a system for controlling a mission of an unmanned aerial vehicle;

FIG. 2 is a diagram illustrating a MAVlink stream transmission structure, which is a communication protocol between an unmanned aerial vehicle and an unmanned aerial vehicle controller;

FIGS. 3A to 3C are tables showing data parameters for transmitting user and target position defined for a return function of an unmanned aerial vehicle;

FIG. 4 is a diagram illustrating an unmanned aerial vehicle mission management unit in an unmanned aerial vehicle;

FIGS. 5A and 5B are diagrams illustrating an automatic return method of an unmanned aerial vehicle;

FIGS. 6A and 6B are diagrams illustrating an automatic return method based on a user position;

FIG. 7 is a diagram illustrating a method of controlling a mission of an unmanned aerial vehicle on the basis of a user position; and

FIG. 8 is a diagram illustrating a position information transmission method based on a user position.

### DETAILED DESCRIPTION OF THE INVENTION

Hereinbelow, embodiments of the present invention will be described in detail so that those skilled in the art can easily carry out the present invention referring to the accompanying drawings. However, the present disclosure may be embodied in many different forms and is not limited to the embodiments described herein.

In the following description of the embodiments of the present invention, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, when an element is referred to as being “connected”, “joined”, or “attached” to another element, it is understood to include not only a direct connection relationship but also an indirect connection relationship. Also, when an element is referred to as “containing” or “having” another element, it means not only excluding another element but also further including another element.

In the present disclosure, the terms first, second, and so on are used only for the purpose of distinguishing one element from another, and do not limit the order or importance of the elements unless specifically mentioned. Thus, within the scope of this disclosure, the first component in an embodiment may be referred to as a second component in another embodiment, and similarly a second component in an embodiment may be referred to as a second component in another embodiment.

In the present disclosure, components that are distinguished from one another are intended to clearly illustrate each feature and do not necessarily mean that components are separate. That is, a plurality of components may be integrated into one hardware or software unit, or a single component may be distributed into a plurality of hardware or software units. Accordingly, such integrated or distributed embodiments are also included within the scope of the present disclosure, unless otherwise noted.

In the present disclosure, the components described in the various embodiments do not necessarily mean essential components, but some may be optional components. Accordingly, embodiments consisting of a subset of the components described in an embodiment are also included within the scope of this disclosure. Also, embodiments that include other components in addition to the components described in the various embodiments are also included in the scope of the present disclosure.

The advantages and features of the present invention and the manner of achieving them will be apparent from and elucidated with reference to the embodiments described hereinafter in conjunction with the accompanying drawings. The present invention may, however, be embodied in many different forms and should not be construed as limited to the embodiments set forth herein. Rather, these embodiments are provided so that this disclosure will be thorough and complete, and will fully convey the scope of the invention to those skilled in the art.

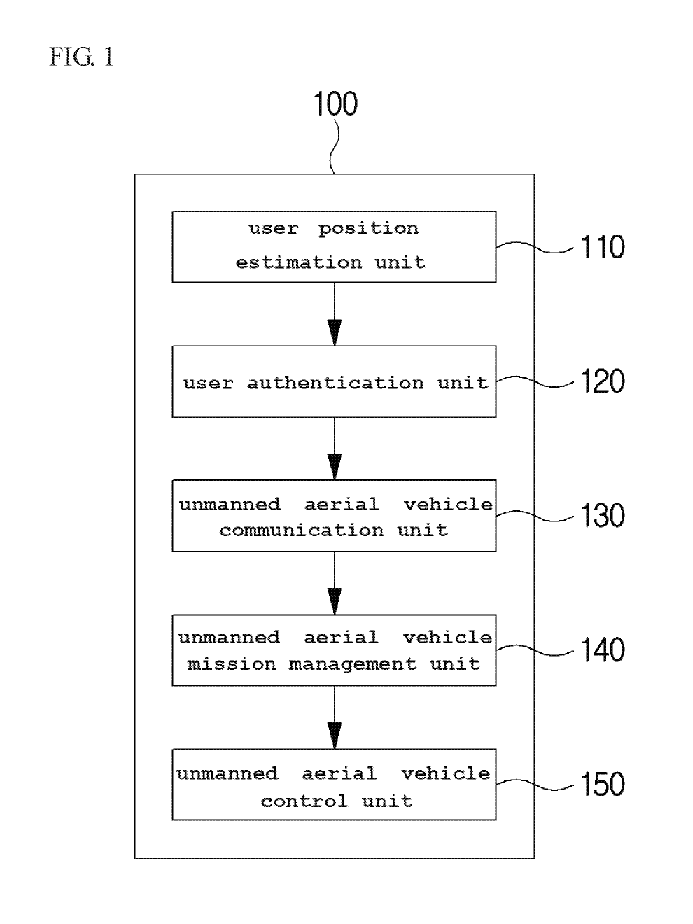

The present invention may provide a system for controlling a mission of an unmanned aerial vehicle on the basis of a user position. Herein, FIG. 1 is a block diagram illustrating a system for controlling a mission of an unmanned aerial vehicle on the basis of a user position according to an embodiment of the present invention.

According to an aspect of the present invention, a system for controlling a mission of an unmanned aerial vehicle (hereinafter, referred to as “unmanned aerial vehicle mission control system”) includes a user position estimator 110 for determining the position of an unmanned aerial vehicle user via a GPS possessed by an unmanned aerial vehicle user or a device capable of determining the user position. Herein, the unmanned aerial vehicle mission control system may estimate the user position by exchanging signals with the unmanned aerial vehicle controller having GPS or position information transmitting device possessed by the user. That is, the user position estimation unit 110 may determine the user position on the basis of the received user position information. Also, the unmanned aerial vehicle mission control system may include a user authentication unit 120 for authenticating the authority to connect to the unmanned aerial vehicle in order to deliver the user position to the unmanned aerial vehicle. That is, only the authenticated user may be allowed to access the unmanned aerial vehicle mission control system, and the user authentication unit 120 may include user ID information or encryption information for authentication, but the present invention is not limited thereto.

In addition, the unmanned aerial vehicle mission control system may also include an unmanned aerial vehicle communication unit 130 for transmitting the authenticated user position information to the unmanned aerial vehicle. Also, the unmanned aerial vehicle mission control system may include an unmanned aerial vehicle mission management unit 140 for receiving the user position information and applying the same to the current unmanned aerial vehicle mission, which will be described later. Also, the unmanned aerial vehicle mission control system may include an unmanned aerial vehicle control unit 150 for controlling the unmanned aerial vehicle to adjust the movement route according to the applied mission. In other words, the unmanned aerial vehicle mission control system may control a movement route for a specific mission on the basis of the user position information, which is followed by the mission control for the unmanned aerial vehicle.

In addition, for example, an unmanned aerial vehicle mission control system may operate on the basis of the position of a third person. As an example, the delivery system may perform a mission to deliver the item to a particular user position, which will be described below. Herein, the user position estimation unit 110 of the unmanned aerial vehicle mission control system may determine the position of the third person through a GPS possessed by the third person or another person or a device capable of determining the user position. Also, the unmanned aerial vehicle communication unit 130 may transmit the authenticated position information of the third person to the unmanned aerial vehicle. In addition, the unmanned aerial vehicle mission management unit 140 may receive the position information of the third person and set the same as a given mission target point. Also, the unmanned aerial vehicle control unit 150 may control the unmanned aerial vehicle and adjust the movement path in order to perform the given mission according to the input position information of the third person.

According to an embodiment of the present invention, the unmanned aerial vehicle mission control system 100 based on the user position may include at least one of a user position estimation unit 110, a user authentication unit 120, an unmanned aerial vehicle communication unit 130, an unmanned aerial vehicle mission management unit 140, and an unmanned aerial vehicle control unit 150.

The user position estimation unit 110 estimates and tracks the position of the third person or the user who operates the unmanned aerial vehicle, by using a GPS in the terminal (or position tracking technology of Communication company) owned by the unmanned aerial vehicle user or the third person who is a target of the mission. Herein, a device capable of estimating the user position may be separately provided inside or outside the unmanned aerial vehicle control unit. For example, the user position estimation unit 110 may be a base station or the like. More specifically, the base station may estimate and track the terminal position of the unmanned aerial vehicle user or the third person through the network information and the GPS information of the user terminal as the user position estimation unit 110. As another example, the user position estimation unit 110 may be a separate server, device, or machine. As another example, the user position estimation unit 110 may be provided in an unmanned aerial vehicle. The user position estimation unit 110 may be configured to estimate the user position, but the present invention is not limited thereto.

In addition, for example, the user authentication unit 120 may perform user authentication when there is no device capable of estimating the user position in the unmanned aerial vehicle control unit. In this case, the user position is estimated using an external device capable of identifying the position, and when the estimated user position is transmitted to the unmanned aerial vehicle, the user authentication unit 120 may authenticate the user. Thereafter, a function for accessing the unmanned aerial vehicle communication unit 130 may be performed. For example, at the time of user authentication, identification information such as ID information and the like may be used. In addition, security and authentication-related key information may be utilized, but the present invention is not limited thereto.

In addition, the unmanned aerial vehicle communication unit 130 may use a wireless communication method, such as Wi-Fi, LTE, NR, telemetry, and the like, as a module for periodically transmitting the position information of the user or the third person to the unmanned aerial vehicle. As an example, an unmanned aerial vehicle may also be a communicatable device in order to perform communication with the unmanned aerial vehicle communication unit 130. For example, an unmanned aerial vehicle may be equipped with a module for performing communication. As described above, the unmanned aerial vehicle communication unit 130 may transmit the position information to the unmanned aerial vehicle over the existing network. In addition, the unmanned aerial vehicle communication unit 130 sets up an unmanned aerial vehicle dedicated network and may transmit the position information based on the unmanned aerial vehicle dedicated network. In this patent, the types of networks are not limited to the above-described embodiments. Also, for example, the unmanned aerial vehicle communication unit 130 may periodically provide the position information to the unmanned aerial vehicle during mission performance. As another example, the period of the signal provided by the unmanned aerial vehicle communication unit 130 may be set differently on the basis of the speed or position of the unmanned aerial vehicle, the communication protocol standard, and the like, but the present invention is not limited thereto.

In addition, the unmanned aerial vehicle mission management unit 140 may perform a function of scheduling a mission in such a manner to receive the position information of the user or the third person and perform operations such as automatic return, position tracking, and the like according to the information. Herein, the unmanned aerial vehicle mission management unit 140 calculates the movable distance through the battery capacity and the computed current output of the unmanned aerial vehicle on the basis of the user position information and updates the input mission on the basis of the distance. Herein, as an example, the unmanned aerial vehicle mission management unit 140 may manage whether to execute the mission and information necessary for the mission performance, but the present invention is not limited thereto.

The unmanned aerial vehicle control unit 150 may perform an operation to control the unmanned aerial vehicle in order to move the unmanned aerial vehicle to the updated position of the user or the third person.

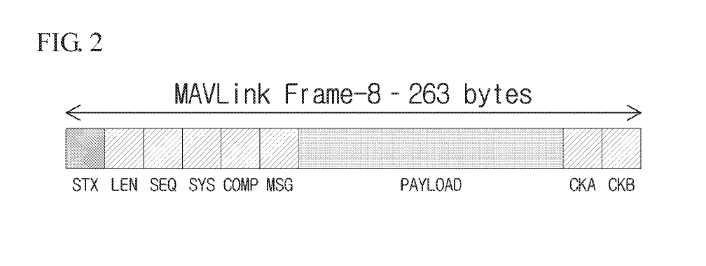

FIG. 2 is a diagram illustrating a drone communication protocol for a return to user position. As an example, the return to user position may mean that the unmanned aerial vehicle acquires the user position information via communication, and returns to the user position on the basis of the information, which will be described later. Herein, as an example, a MAVlink packet structure may be used as a drone communication protocol. Herein, the MAVlink may be a message format used when the control station on the ground and the unmanned aerial vehicle perform communication therebetween. The basic structure of the MAVlink packet may include at least one of STX, LEN, SEQ, SYS, COMP, MSG, payload, CKA, and CKB. However, the above-described format is only one example, and some fields may be omitted or other fields may be added, but the present invention is not limited thereto. In this case, for example, STX may be a field indicating a new start. Also, the LEN field is an indicator indicating the length of the payload. Also, the SEQ is a packet sequence. Also, COMP is a component ID, and MSG is a message ID. In addition, the payload is a field in which the actual data of the message is composed.

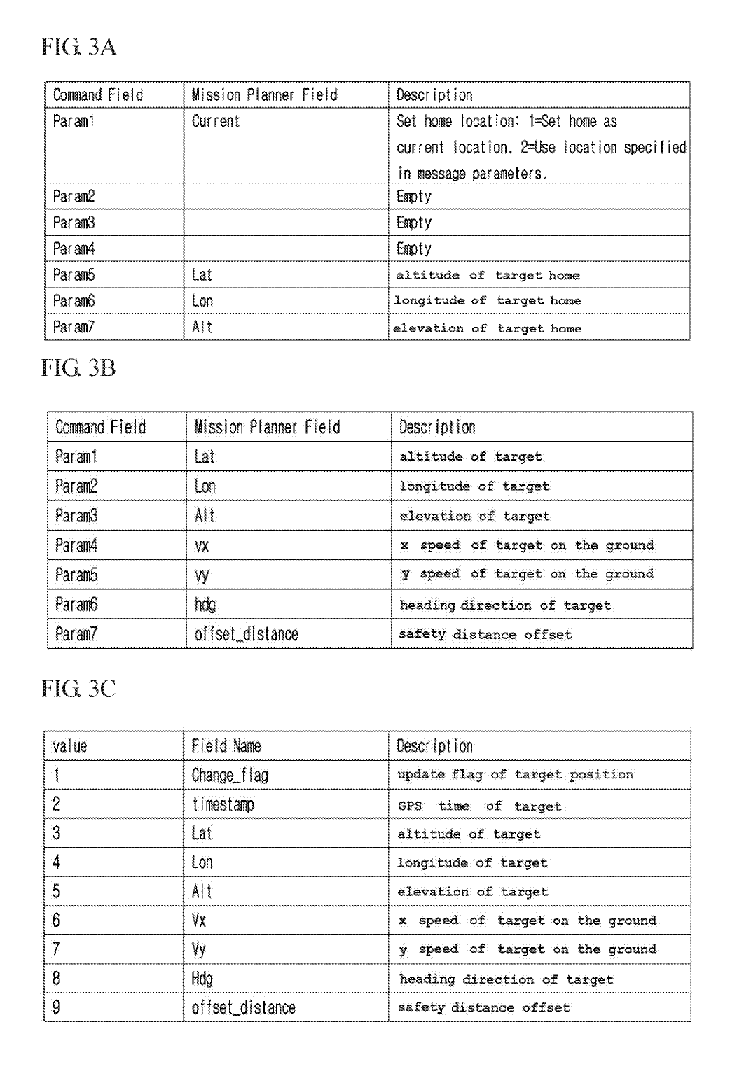

Herein, for example, a message for the automatic return function of the unmanned aerial vehicle based on the above-described format to be described below may be transmitted on the basis of the MAVlink packet. In this case, for example, FIG. 3A may be a command message implemented for a return home function defined in the existing MAVlink. Referring to FIG. 3A, a mission command for the return home may only specify latitude, longitude, and elevation of the initial home. Thus, the unmanned aerial vehicle may designate only the home position or the current position of the unmanned aerial vehicle as the home on the basis of the mission command.

However, the automatic return based on the user position may be necessary as described above, and to this end, there is a need to further configure additional information using the MAVlink format. Herein, for example, as a method of sending data for the return to user position to the unmanned aerial vehicle, a method of defining and transmitting a new mission command of the MAVlink and a method of transmitting the user defined message in the MAVlink packet are considered.

For example, referring to FIG. 3B, a new mission command of the MAVlink may be defined to transmit data for the return to user position to the unmanned aerial vehicle. Herein, parameters “param 1 to param 7” may be defined in the MAVlink, and information necessary for them may be transmitted.

More specifically, the respective parameters param1, param2 and param3 may represent the latitude, longitude, and elevation of the current target, respectively. In addition, the parameter param4 may indicate x speed as the current target. Also, the parameter param5 may indicate y speed of the current target. That is, they may indicate x and y speeds of the target with respect to the moving direction based on the ground. Also, the parameter param6 may specify the heading direction of the current target. In addition, the parameter param1 may specify an offset distance as a safety distance for preventing a collision between the user and the unmanned aerial vehicle when the unmanned aerial vehicle returns directly to the user position at the time of return operation. Herein, the safety distance offset may be changed by designation of the user.

Herein, when the unmanned aerial vehicle returns to the user position on the basis of FIG. 3B, the unmanned aerial vehicle may perform the return function on the basis of the return parameter. For example, when operating an unmanned aerial vehicle, the unmanned aerial vehicle operator may continuously transmit the user position information to the unmanned aerial vehicle in the form of a MAVlink packet. The unmanned aerial vehicle may obtain the current user position information through the data of param1, param2, and param3 among the received user position return packets. In other words, the unmanned aerial vehicle may know the user position. In addition, the unmanned aerial vehicle may obtain information about the current movement speed and direction of the user through the parameters param4, param5, and param6. For example, when the communication between the unmanned aerial vehicle and the user is broken, the unmanned aerial vehicle may estimate the user position on the basis of the movement speed and direction of the user, which are received immediately before the communication is broken.

In addition, the unmanned aerial vehicle may check the safety distance information, in order to prevent collision with the user when performing return and landing on the basis of information included in param 7. For example, when “offset_distance” is 0 as param 7, the unmanned aerial vehicle may return to the position transmitted by the user. Also, for example, when “offset_distance” is non-zero, the unmanned aerial vehicle may move from the user position to a safe area (or by a safety distance) and then perform landing. Also, the unmanned aerial vehicle may perform landing in a safe zone on the basis of a separately implemented operation, but the present invention is not limited thereto.

That is, as described above, the unmanned aerial vehicle may configure and exchange data for automatic return to user position using the existing format in the MAVlink. Herein, the existing frame format is maintained and thus operated in consideration of compatibility with other unmanned aerial vehicles, and the existing fields may be reused, thereby facilitating implementation convenience.

There is considered a method of efficiently limiting the number of parameters (e.g., param 1 to param 7) for the mission command, and defining and transmitting the user message to the MAVlink packet for efficient and stable home return.

For example, referring to FIG. 3C, the user defined message may be similar to the mission command, but may further include a “change_flag” field indicating an update of the current position of the user. Further, a current “timestamp” of the user may be further defined in consideration of synchronization. Herein, the change_flag may be a field for checking whether the user position is changed from the data received before. As an example, when the change_flag is 0, it may indicate that the user position is not changed. The timestamp indicates the time when the user position is transmitted and may be used to predict the user position or to perform time synchronization with the unmanned aerial vehicle.

Herein, the user defined message may further include additional information so that the unmanned aerial vehicle may perform an automatic return to the user position. For example, battery information, communication environment information, and the like of the user device may be further included in consideration of the communication interruption occurrence. As an example, the user device may provide battery information to the unmanned aerial vehicle in order to provide information on how long the unmanned aerial vehicle control may last. In addition, for example, the user device may provide communication environment information, channel information, and the like to the unmanned aerial vehicle in consideration of radio interference and the like. The unmanned aerial vehicle may predict that communication interruption with the user will occur on the basis of the information. In addition, the user defined message may have nine values as shown in FIG. 3C, or have more than nine. For example, the user defined message may be defined as 4 bits (16), including information related to the unmanned aerial vehicle, and some bits may be composed of reserved bits. For example, when there is additional information associated with an unmanned aerial vehicle or the user wishes to transmit the information to the unmanned aerial vehicle, the user device may further transmit additional information to the unmanned aerial vehicle via the reserved bit, but the present invention is not limited thereto.

In addition, with respect to a user defined message, when the above-described change_flag indicates that the position of the target is not updated, the user defined message may include only the change_flag and timestamp fields described above. That is, when there is no position change, the user device may set change_flag to 0 and transmit only the timestamp information to the unmanned aerial vehicle. This makes it possible to prevent unnecessary data transmission. In addition, when the user device detects that the position is changed, the user device may set the change_flag to 1 and transmit the information to the unmanned aerial vehicle along with the information defined in FIG. 3C. Accordingly, the unmanned aerial vehicle may recognize that the user position information is changing and thus check the changed information. That is, it is possible to perform automatic return to the user position through the above-described procedure.

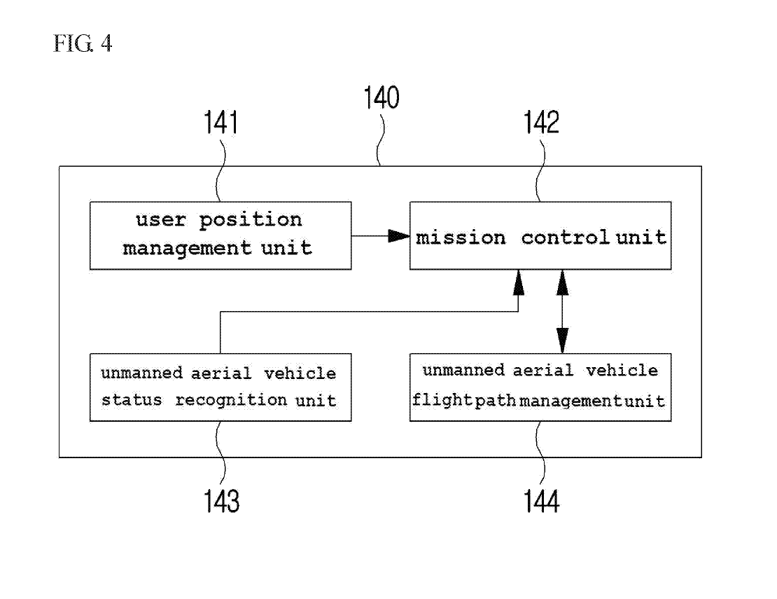

FIG. 4 is a drawing illustrating an unmanned aerial vehicle mission management unit of an unmanned aerial vehicle.

The unmanned aerial vehicle mission management unit 140 includes at least one of a user position management unit 141, user position prediction unit 142, a mission control unit 143, an unmanned aerial vehicle status recognition unit 144, and an unmanned aerial vehicle flight path management unit 145. Herein, the user position management unit 141 may continuously receive the position information of an unmanned aerial vehicle user or a third person on the ground and perform an operation of matching the position information with the current position information of the unmanned aerial vehicle. For example, as described above, the unmanned aerial vehicle communication unit 130 may continuously provide the position information to the user position management unit 141 while performing the mission, thereby managing a flight path of the unmanned aerial vehicle.

In addition, when communication with the unmanned aerial vehicle control unit on the ground is interrupted, the user position prediction unit 142 performs a function of estimating the current target position on the basis of the previously received target position information to perform a return operation. When communication with the unmanned aerial vehicle user is interrupted while the unmanned aerial vehicle is operated, it is impossible to return to the user position only by the position information received before communication interrupted in an environment such as on the sea. In order to solve this, operations are performed to store the user position information received before the communication is interrupted in a buffer and predict the future user position on the basis of x and y speeds and the traveling direction of the accumulated target information, in which the unmanned aerial vehicle may perform a return operation to the predicted user position. Herein, the unmanned aerial vehicle may receive the user information from the user on the basis of the MAVlink packet as described above, and predict the user position on the basis of the information. However, since it is difficult to predict the exact position of the user only by the above-mentioned values, the operation of the user position prediction unit is stopped when reaching the position where communication with the user is possible again, and the return operation of the unmanned aerial vehicle may be performed on the basis of the user information received again.

Also, the unmanned aerial vehicle status recognition unit 144 may perform a function of checking the current battery state and motor output state of the unmanned aerial vehicle and thus predicting the operable time of the unmanned aerial vehicle.

The unmanned aerial vehicle flight path management unit 145 performs a function of managing the flight path input by the user, storing the input flight path, and allowing the unmanned aerial vehicle to be flight according to the input flight path when the path is changed.

The mission control unit 143 may perform a function of updating mission in order to check the operable time of the unmanned aerial vehicle on the basis of the current user position and the status information of the unmanned aerial vehicle and move the unmanned aerial vehicle to the position of the user or the third person. That is, the mission control unit 143 may determine whether the mission is continued or not by using comprehensive information such as the user position, the unmanned aerial vehicle state, the unmanned aerial vehicle flight path, and the like. In addition, the mission control unit 143 may update the mission through the above-described information and perform control on how to perform the mission. That is, the mission may be performed using the above-described information, but the present invention is not limited thereto.

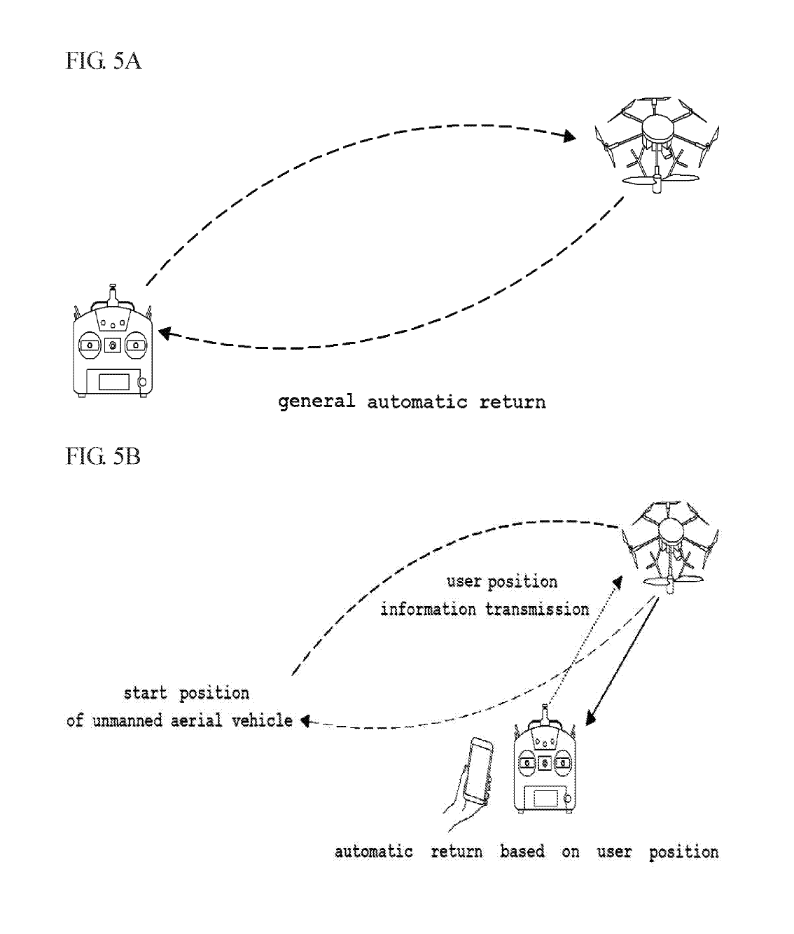

FIGS. 5A and 5B are diagrams illustrating an automatic return method of an unmanned aerial vehicle.

FIGS. 5A and 5B are diagrams illustrating an example of an automatic return function based on the position information of the unmanned aerial vehicle user described above. Referring to FIG. 5A, a general automatic return method of the unmanned aerial vehicle without using the user position information is shown. Herein, the unmanned aerial vehicle may store an initial start position in internal software of the unmanned aerial vehicle and return to the initial start position when the return command is called. However, in this case, the unmanned aerial vehicle user must wait for the return of the unmanned aerial vehicle at the initial start position and is restricted to operate the unmanned aerial vehicle because the return function is based on the initial start position.

Referring to FIG. 5B, the automatic return of the unmanned aerial vehicle may be performed on the basis of user position information. The user may periodically transmit the user position to the unmanned aerial vehicle using the user terminal capable of estimating the position. Herein, the information about the user may be transmitted to the unmanned aerial vehicle on the basis of the MAVlink packet, as described above. The unmanned aerial vehicle may update the return position on the basis of the received user position information. Herein, the unmanned aerial vehicle may have a merit that it may operate a much longer distance than the general automatic return described above. In addition, the automatic return method may be selectively performed. For example, when the unmanned aerial vehicle does not acquire the user position information or has a difficultly to perform communication, the unmanned aerial vehicle may return to the initial position.

For example, communication between the unmanned aerial vehicle and the terminal or the unmanned aerial vehicle mission control system may be unstable according to the distance between the unmanned aerial vehicle and the terminal Herein, the unmanned aerial vehicle may return to the last identified user position. As another example, in order to prevent an error when communication is impossible, the unmanned aerial vehicle may set the initial start position to the default position and perform the return. In this way, when the control for the unmanned aerial vehicle is possible, the unmanned aerial vehicle may be controlled to perform the mission. Also, when the mission cannot be performed, the unmanned aerial vehicle may be returned to the initial position, thereby preventing an accident or loss of the unmanned aerial vehicle.

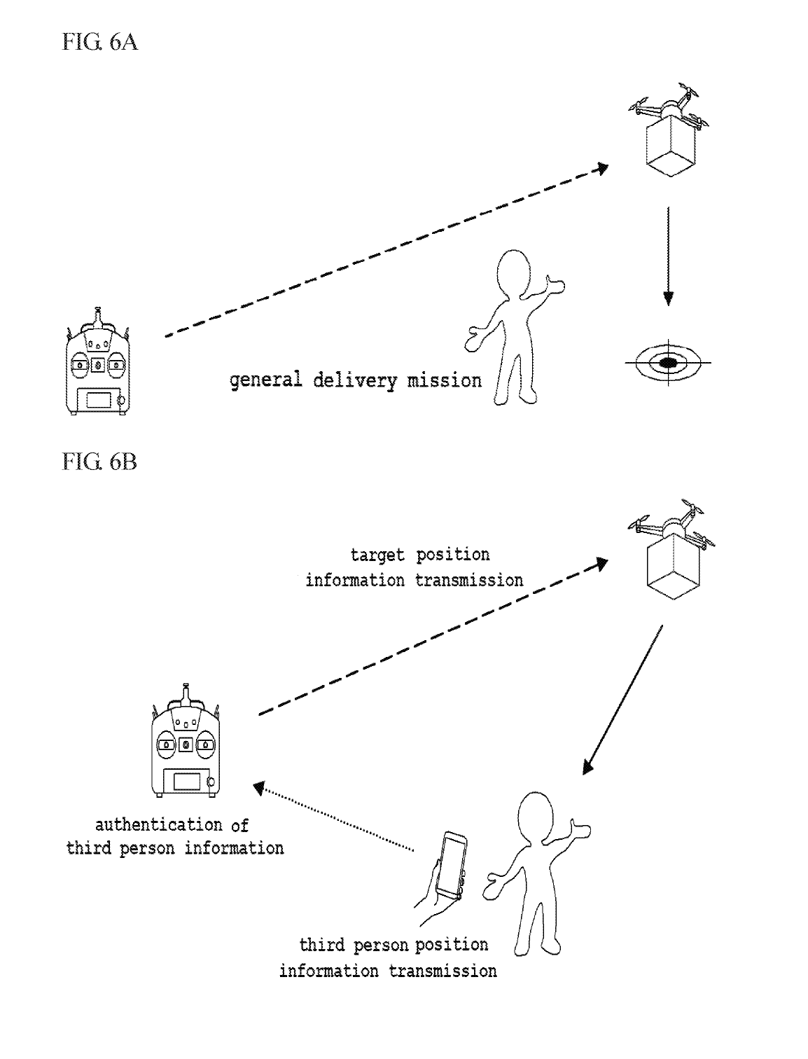

FIGS. 6A and 6B are diagrams illustrating an automatic return method based on the user position. FIGS. 6A and 6B show an example of an unmanned aerial vehicle delivery mission based on the position information of the third person as described above. FIG. 6A may be a delivery scenario for a typical unmanned aerial vehicle. Herein, the unmanned aerial vehicle user sets a pre-input delivery destination as a flight path of the unmanned aerial vehicle, and the unmanned aerial vehicle may deliver the goods along the input path. However, this method has a problem in that it is impossible to deliver goods to a third person.

Here, FIG. 6B shows a scenario of an unmanned aerial vehicle delivery mission using the position information of the third person. The unmanned aerial vehicle user may receive the third person's position information of the delivery destination over communication network and set the delivery path of the goods according to this information. The unmanned aerial vehicle user may also update the position of the third person by periodic communication with the third person, and update the information to the unmanned aerial vehicle when the third person moves, thereby changing the delivery position.

That is, as described above, according to the unmanned aerial vehicle mission control system, the unmanned aerial vehicle periodically checks the information about the user or the third person, and periodically performs the update for the mission performance. This makes it possible to perform a return command or a mission command on the basis of the position of the user of the unmanned aerial vehicle or drone or third person, thereby increasing the operable distance of the unmanned aerial vehicle and thus performing more accurate mission commands.

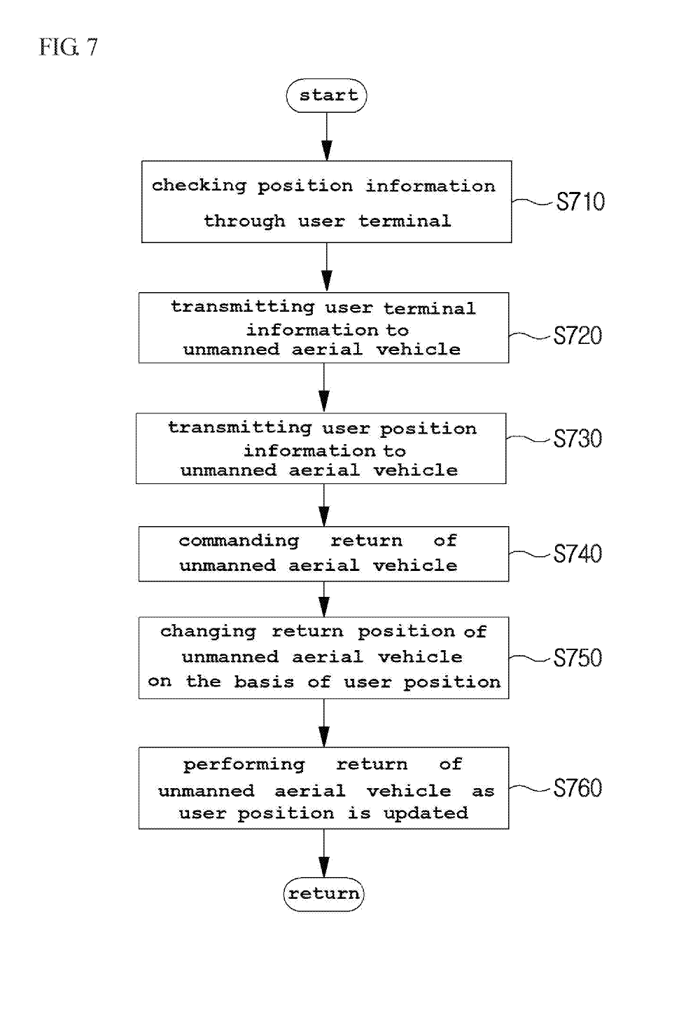

FIG. 7 is a diagram illustrating an unmanned aerial vehicle mission control method based on a user position.

Referring to FIG. 7, an unmanned aerial vehicle user having a terminal capable of estimating the user position by a GPS or a position tracking service of a communication company checks its own position (S710). Herein, as described in FIGS. 1 to 6, the position information of the user terminal or the position information of the third person terminal may be checked. That is, position information of the target terminal may be checked for mission performance.

Next, when the position of the unmanned aerial vehicle user is checked, the user authentication operation is performed on the unmanned aerial vehicle communication unit for providing the position information to the unmanned aerial vehicle (S720). Herein, as described in FIGS. 1 to 6, identification information or authentication and security information for the user or the third person make it possible to prevent unauthorized users from accessing the unmanned aerial vehicle.

Next, when the unmanned aerial vehicle communication unit is authenticated to access the unmanned aerial vehicle, the unmanned aerial vehicle communication unit periodically transmits the position information to the unmanned aerial vehicle (S730). Herein, as shown in FIGS. 1 to 6, the unmanned aerial vehicle may periodically check the position of the user terminal or the third person terminal to perform the mission and update the mission, thereby improving the accuracy of mission performance.

Next, commanding return of the unmanned aerial vehicle (S740) is used to send the mission that allows the unmanned aerial vehicle user to land the unmanned aerial vehicle on the user position and return the unmanned aerial vehicle by checking the battery state of the unmanned aerial vehicle using the unmanned mission management unit. For example, in the unmanned aerial vehicle mission management unit described above, the information on the unmanned aerial vehicle may be integrated to perform the return command of the unmanned aerial vehicle.

Herein, when the return command of the unmanned aerial vehicle is called, the unmanned aerial vehicle changes the existing return position of the unmanned aerial vehicle from the take-off start position to the current user position (S750). Herein, as shown in FIGS. 1 to 6, the return of the unmanned aerial vehicle may be performed on the basis of the position of the user or third person terminal. In addition, for example, an unmanned aerial vehicle may return to its initial position as a default position when the communication is impossible or it is difficult to obtain information.

In addition, as an example, when the unmanned aerial vehicle is capable of performing communication or obtaining information, the unmanned aerial vehicle is controlled such that the user position is updated by continuously tracking the user position through communication with the unmanned aerial vehicle user, thereby performing return to the user position (S760). Accordingly, the unmanned aerial vehicle may be controlled on the basis of the user position, but the present invention is not limited thereto.

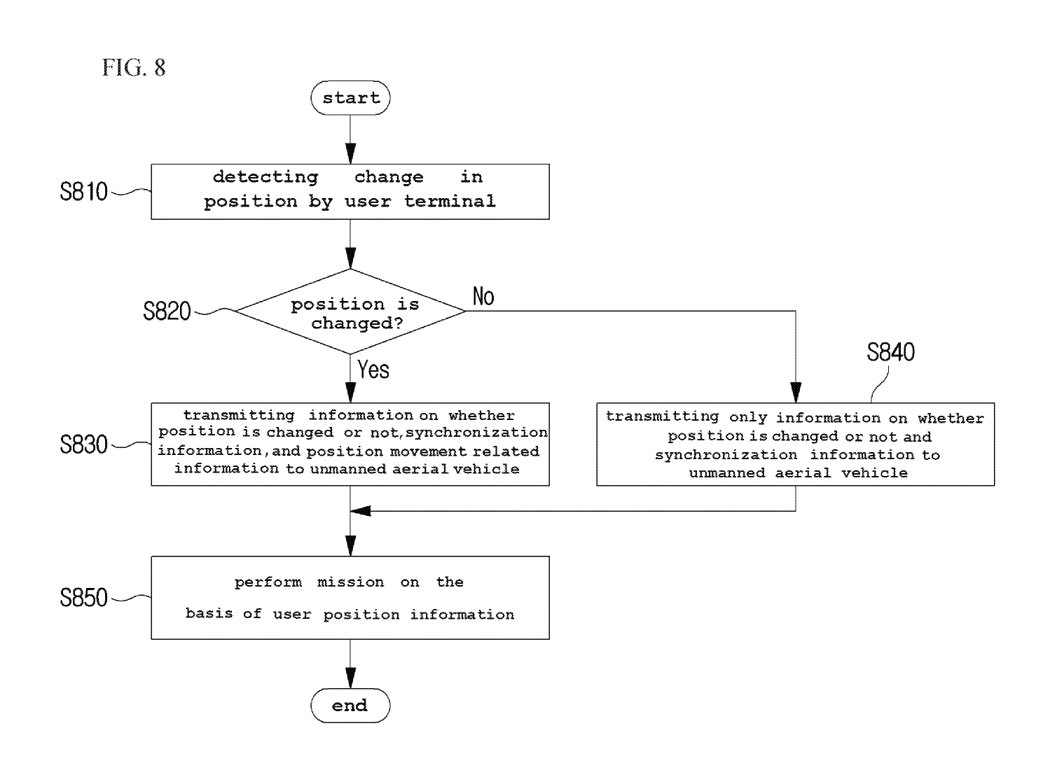

FIG. 8 is a diagram illustrating a method of transmitting information to an unmanned aerial vehicle on the basis of the positional change of a user terminal.

Referring to FIG. 8, the user terminal may detect a change in position (S810). Herein, for example, the user terminal may be a terminal for controlling the unmanned aerial vehicle as described above, and a terminal used for returning the unmanned aerial vehicle to the user position. For example, the user terminal may detect the change in position using a gyro sensor, an acceleration sensor, or the like. Herein, the user terminal may detect the change in position only when the user terminal moves by a reference distance. That is, the fine movement of the user may not be recognized as the change in position. Herein, when the user terminal is changed in position (S820), the user terminal may transmit information on whether the position is changed or not, synchronization information, and the position movement related information to the unmanned aerial vehicle (S830). On the other hand, when the user terminal does not change in position (S820), the user terminal may transmit the information on whether the position is changed or not and the synchronization information to the unmanned aerial vehicle (S840). Herein, as shown in FIGS. 3A to 3C, the information on the position change is a change flag, and the synchronization information may be a timestamp. That is, the user terminal may provide the unmanned aerial vehicle only with the change flag that, when the position has not changed, performs notification thereof, and the timestamp which is information on the time.

On the other hand, when the position of the user terminal has changed, the user terminal may further provide the unmanned aerial vehicle with the position change related information as well as the above information. That is, the information included in FIG. 3C may be further provided to the unmanned aerial vehicle. Accordingly, the unmanned aerial vehicle recognizes that the user terminal is moving and checks information on the movement.

Thereafter, the unmanned aerial vehicle may perform the mission on the basis of the user position information (S850), as shown in FIGS. 1 to 7. Also, as an example, an unmanned aerial vehicle may automatically return to the user position on the basis of the user position information, as described above.

Although the exemplary methods of this disclosure are represented by a series of steps for clarity of explanation, they are not intended to limit the order in which the steps are performed, and if necessary, each step may be performed simultaneously or in a different order. In order to implement the method according to the present disclosure, it is possible to include other steps to the illustrative steps additionally, exclude some steps and include remaining steps, or exclude some steps and include additional steps.

The various embodiments of the disclosure are not intended to be exhaustive of all possible combination, but rather to illustrate representative aspects of the disclosure, and the features described in the various embodiments may be applied independently or in a combination of two or more.

In addition, various embodiments of the present disclosure may be implemented by hardware, firmware, software, or a combination thereof. In the case of hardware implementation, it may be implemented by one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, a microprocessor, and the like.

The scope of the present disclosure includes software or machine-executable instructions (e.g., an operating system, applications, firmware, and a program) that allow operations according to the various embodiments to be executable in device or computer, and a non-transitory computer-readable medium that is executable in the device or computer in which such software or instructions are stored.

1. A method of controlling an unmanned aerial vehicle by a terminal in a system for controlling a mission of the unmanned aerial vehicle, the method comprising:
acquiring information related to a position for the terminal;
performing authentication for the unmanned aerial vehicle on the basis of the information related to the position of the terminal; and
when the authentication is completed, transmitting the information related to the position of the terminal to the unmanned aerial vehicle.

2. The method of claim 1, wherein the information related to the position of the terminal is transmitted to the unmanned aerial vehicle on the basis of a MAVlink packet.

3. The method of claim 2, wherein the information related to the position is transmitted on the basis of at least one of a first format and a second format based on the MAVlink packet.

4. The method of claim 3, wherein the first format is a legacy format based on the MAVlink packet, and the second format is a format based on the information related to the position.

5. The method of claim 4, wherein when the information related to the position is transmitted to the unmanned aerial vehicle on the basis of the first format, the information related to the position is included as a predetermined value in the first format.

6. The method of claim 4, wherein when the information related to the position is transmitted to the unmanned aerial vehicle on the basis of the second format, a new value is set on the basis of the information related to the position, and the information related to the position is transmitted via the set new value.

7. The method of claim 1, wherein the information related to the position includes at least one of latitude information, longitude information, elevation information, x speed on the ground, y speed on the ground, a heading direction, position update flag information, time information, and safety distance offset information of the terminal.

8. The method of claim 7, wherein when the position update flag information is a first value, the information related to the position includes only the position update flag information and the time information.

9. The method of claim 7, wherein when the position update flag information is a second value, the information related to the position includes all of the latitude information, the longitude information, the elevation information, the x speed on the ground, the y speed on the ground, the heading direction, the position update flag information, the time information, and the safety distance offset information.

10. A method of controlling an unmanned aerial vehicle in a system for controlling a mission of an unmanned aerial vehicle, the method comprising:
receiving information related to a position from a terminal; and
performing mission control on the basis of the information related to the position,
wherein authentication for the unmanned aerial vehicle is performed on the basis of the information related to the position of the terminal, and when the authentication is completed, the information related to the position of the terminal is transmitted to the unmanned aerial vehicle.

11. The method of claim 10, wherein the unmanned aerial vehicle performs an automatic return mission to a position of the terminal on the basis of the information related to the position.

12. The method of claim 10, wherein the information related to the position of the terminal is transmitted to the unmanned aerial vehicle on the basis of a MAVlink packet.

13. The method of claim 12, wherein the information related to the position is transmitted on the basis of at least one of a first format and a second format based on the MAVlink packet.

14. The method of claim 13, wherein the first format is a legacy format based on the MAVlink packet, and the second format is a format based on the information related to the position.

15. The method of claim 14, wherein when the information related to the position is transmitted to the unmanned aerial vehicle on the basis of the first format, the information related to the position is included as a predetermined value in the first format.

16. The method of claim 14, wherein when the information related to the position is transmitted to the unmanned aerial vehicle on the basis of the second format, a new value is set on the basis the information related to the position, and the information related to the position is transmitted via the set new value.

17. The method of claim 11, wherein the information related to the position includes at least one of latitude information, longitude information, elevation information, x speed on the ground, y speed on the ground, a heading direction, position update flag information, time information, and safety distance offset information of the terminal.

18. The method of claim 17, wherein when the position update flag information is a first value, the information related to the position includes only the position update flag information and the time information.

19. The method of claim 17, wherein when the position update flag information is a second value, the information related to the position includes all of the latitude information, the longitude information, the elevation information, the x speed on the ground, the y speed on the ground, the heading direction, the position update flag information, the time information, and the safety distance offset information.

20. A system for controlling a mission of an unmanned aerial vehicle, the system comprising:
an unmanned aerial vehicle; and
a terminal controlling the unmanned aerial vehicle,
wherein the terminal acquires information related to a position,
the terminal performs authentication for the unmanned aerial vehicle on the basis of the information related to the position, and
the terminal transmits the information related to the position of the terminal to the unmanned aerial vehicle when the authentication is completed.
